(19) United States
(12) Patent Application Publication
(10) Pub. No.: US 2014/0293020 A1
(43) Pub. Date: Oct. 2, 2014

(54) DISPLAY DEVICE

(71) Applicant: Japan Display Inc., Tokyo (JP)

(72) Inventor: Toshinori UEHARA, Tokyo (JP)

(73) Assignee: Japan Display Inc., Tokyo (JP)

(21) Appl. No.: 14/220,925

(22) Filed: Mar. 20, 2014

(30) Foreign Application Priority Data
Mar. 28, 2013 (JP) 2013-070201

(51) Int. Cl. H04N 13/04

(52) U.S. Cl. CPC H04N 13/0468; H04N 13/0477; H04N 13/0475
USPC 348/51

(57) ABSTRACT

A display device includes a display unit that displays a moving image, a detection unit that detects a position of a user, a calculation unit that calculates a moving speed of the user on the basis of a frame time and an amount of transition of the position detected by the detection unit, a position estimation unit that calculates an estimated position of the user when the moving speed calculated by the calculation unit is higher than a threshold value, and that does not calculate the estimated position when the moving speed is equal to or lower than a threshold value, and an image adjustment unit that performs adjustment of an image to be displayed on the display unit on the basis of the estimated position, when the estimated position is calculated by the position estimation unit.

### CROSS REFERENCES TO RELATED APPLICATIONS

The present application claims priority to Japanese Priority Patent Application JP 2013-070201 filed in the Japan Patent Office on Mar. 28, 2013, the entire content of which is hereby incorporated by reference.

### BACKGROUND

1. Field of the Invention

The present disclosure relates to a display device.

2. Description of the Related Art

In recent years, in a three-dimensional image display device that can display an image (a three-dimensional image) that can be visually recognized three dimensionally by a user who is a viewer, there is a technique to recognize a position of the user, and to adjust a display image on the basis of a result of the recognition. However, there is a problem such that a certain amount of time is required for user-position recognition processing, which causes a delay in adjusting the image.

FIG. 26 is an explanatory diagram for explaining the conventional problem. In FIG. 26, a display device 100 detects a position of a user U1 on the basis of an image of the user U1 captured by an image-capturing device 110, and adjusts an image to be displayed on a display surface 120. FIG. 26 illustrates an example case where the user U1 moves at a predetermined speed in an X-axis direction relative to the display device 100. At Step S1, the display device 100 displays an image C1 on the display unit 120. Assuming that at the subsequent Step S2, a certain amount of time is required for position recognition processing for the user U1, a delay in adjusting an image occurs by the amount of time required for the position recognition. Therefore, the display device 100 cannot display an image C2 adjusted according to the position of the user U1 on the display unit 120, and is in a state where the image C1 according to the position of the user U1 at Step S1 remains displayed on the display unit 120. Also at the subsequent Step S3, the display device 100 cannot display an image C3 adjusted according to the position of the user U1 on the display unit 120, and is in a state where the image C2 according to the position of the user U1 at Step S2 remains displayed on the display unit 120. Also at the subsequent Step S4, the display device 100 cannot display an image adjusted according to the position of the user U1 on the display unit 120, and is in a state where the image C3 according to the position of the user U1 at Step S3 remains displayed on the display unit 120. As described above, as a longer time is spent in user-position recognition processing, it is more difficult to adjust an image following the transition of the user position. In order to deal with such a problem, it has been discussed that a user position is estimated, and an image is adjusted according to the estimated position, for example. Japanese Patent Application Laid-open Publication No. H3-296176 discloses a technique to estimate a position of the viewpoint at a future image display time on the basis of the path of the viewpoint, and to generate an image viewed from the estimated position in advance.

In the case of estimating a user position and adjusting an image according to the estimated position, adjustment of the image depends on accuracy of the estimated position. That is, as the user position is estimated more frequently, the possibility of causing an error in the estimation increases to some extent. If there is any error in the estimated user position, there is a possibility to adversely affect the adjustment of the image to some extent.

### SUMMARY

It is an object of the present invention to at least partially solve the problems in the conventional technology.

There is disclosed a display device including a display unit configured to display a moving image, a detection unit configured to detect a position of a user, on the basis of an image of a user, in a first direction horizontal to a display surface of the display unit on which the moving image is displayed, a calculation unit configured to calculate a moving speed of the user, on the basis of a frame time that is a display time per frame composing the moving image, and on the basis of an amount of transition from a position detected by the detection unit during a time of displaying a first frame on the display unit to a position detected by the detection unit during a time of displaying a second frame on the display unit, the second frame being to be displayed later than the first frame, a position estimation unit configured to, when the moving speed calculated by the calculation unit is higher than a threshold value, calculate an estimated position of the user during a time of displaying the second frame on the display unit, on the basis of the position detected by the detection unit during a time of displaying the second frame on the display unit, a detection processing time required for the detection unit to detect the position during a time of displaying the second frame on the display unit, and the moving speed calculated by the calculation unit, and when the moving speed is equal to or lower than the threshold value, calculate no estimated position, and an image adjustment unit configured to, when the estimated position is calculated by the position estimation unit, perform adjustment of an image to be displayed on the display unit on the basis of the estimated position.

The display device according to the present disclosure does not calculate the estimated position of the user, when the moving speed of the user is equal to or less than the threshold value. Namely, the display device according to the present disclosure does not estimate the user position based on any irregular and subtle movement of the user at a relatively slow speed. Therefore, the display device according to the present disclosure can eliminate a possibility to cause an error in estimating the user position as much as possible so as to prevent the occurrence of an error in the estimated user position as much as possible.

The above and other objects, features, advantages and technical and industrial significance of this invention will be better understood by reading the following detailed description of presently preferred embodiments of the invention, when considered in connection with the accompanying drawings.

Additional features and advantages are described herein, and will be apparent from the following Detailed Description and the figures.

### BRIEF DESCRIPTION OF THE FIGURES

FIG. 1 is a block diagram of an example of a functional configuration of a display device according to a first embodiment;

FIG. 2 is a perspective view of an example of a configuration of a backlight, a display unit, and a barrier unit of the display device illustrated in FIG. 1;

FIG. 3 is a perspective view illustrating a relationship between pixels of the display unit and unit areas of the barrier unit;

FIG. 4 is a cross-sectional view of a schematic cross-sectional structure of a module in which a display unit and a barrier unit are incorporated;

FIG. 5 is a circuit diagram illustrating a pixel array in the display unit;

FIG. 6 is a schematic diagram of a pixel for color display;

FIG. 7 is a schematic diagram of a pixel for monochrome display;

FIG. 8 is an explanatory diagram for illustrating an outline of processing by the display device according to the first embodiment;

FIG. 9 is a flowchart illustrating a flow of control by the display device according to the first embodiment;

FIG. 10 illustrates an example of an angular position of a user;

FIG. 11 is a flowchart illustrating a flow of control by a display device according to a second embodiment;

FIG. 12 is an explanatory diagram for illustrating control of a display device according to a third embodiment;

FIG. 13 illustrates an example of an electronic apparatus including the display device according to the embodiments;

FIG. 14 illustrates another example of an electronic apparatus including the display device according to the embodiments;

FIG. 15 illustrates another example of an electronic apparatus including the display device according to the embodiments;

FIG. 16 illustrates another example of an electronic apparatus including the display device according to the embodiments;

FIG. 17 illustrates another example of an electronic apparatus including the display device according to the embodiments;

FIG. 18 illustrates another example of an electronic apparatus including the display device according to the embodiments;

FIG. 19 illustrates another example of an electronic apparatus including the display device according to the embodiments;

FIG. 20 illustrates another example of an electronic apparatus including the display device according to the embodiments;

FIG. 21 illustrates another example of an electronic apparatus including the display device according to the embodiments;

FIG. 22 illustrates another example of an electronic apparatus including the display device according to the embodiments;

FIG. 23 illustrates another example of an electronic apparatus including the display device according to the embodiments;

FIG. 24 illustrates another example of an electronic apparatus including the display device according to the embodiments;

FIG. 25 illustrates another example of an electronic apparatus including the display device according to the embodiments; and

FIG. 26 is an explanatory diagram for explaining a conventional problem.

### DETAILED DESCRIPTION

Modes (embodiments) for carrying out a display device of the present disclosure will be explained in detail with reference to the accompanying drawings. The present disclosure is not limited to the contents described in the following embodiments. Constituent elements described in the following explanations include those that can be easily conceived by persons skilled in the art and that are substantially equivalent. In addition, constituent elements described in the following explanations can be combined as appropriate. Explanations are made with the following order.

1. Embodiments (Display Device)
1-1. First embodiment
1-2. Second embodiment
1-3. Third embodiment

2. Application example (Electronic apparatus)

Example in which a display device according to the above embodiments is applied to an electronic apparatus

3. Configuration of the present disclosure

A display device according to each embodiment explained below can be applied to a display device that controls a barrier unit stacked on a display unit to display a three-dimensional image. Examples of the display unit of the display device include a liquid crystal display (LCD) panel and MEMS (Micro Electro Mechanical Systems).

The display device according to each embodiment can be applied to both a monochrome-display compatible display device and a color-display compatible display device. In the case of the color-display compatible display device, one pixel (a unit pixel) that serves as a unit for composing a color image is configured by plural sub-pixels. More specifically, in the color-display compatible display device, one pixel is configured by three sub-pixels including a sub-pixel that displays a red color (R), a sub-pixel that displays a green color (G), and a sub-pixel that displays a blue color (B), for example.

One pixel is not limited to a combination of sub-pixels of three RGB primary colors, and it is also possible to configure one pixel by further adding a sub-pixel of one color or sub-pixels of plural colors to the sub-pixels of three RGB primary colors. More specifically, it is also possible to configure one pixel by adding a sub-pixel that displays a white color (W) in order to improve the luminance, or to configure one pixel by adding at least one sub-pixel that displays a complementary color in order to expand the color reproduction range, for example.

### 1-1. First Embodiment

(Configuration)

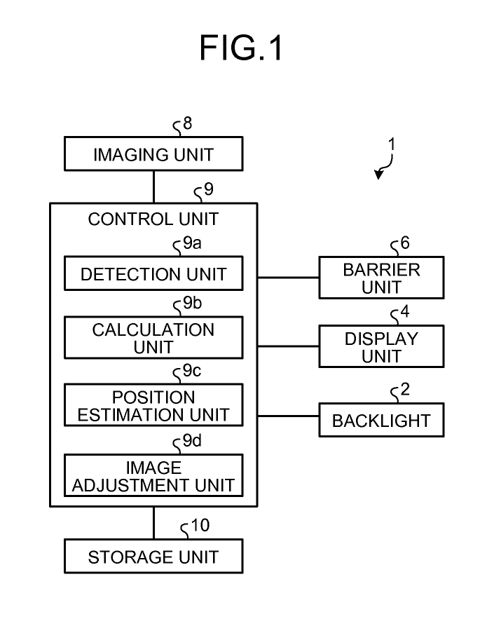

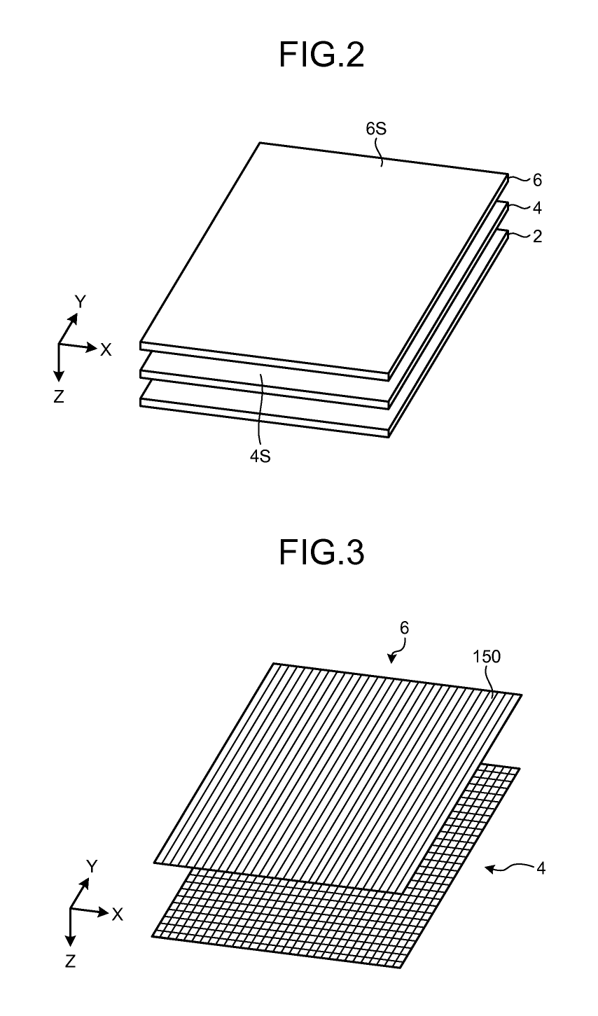

FIG. 1 is a block diagram of an example of a functional configuration of a display device according to a first embodiment. FIG. 2 is a perspective view of an example of a configuration of a backlight, a display unit, and a barrier unit of the display device illustrated in FIG. 1. FIG. 3 is a perspective view illustrating a relationship between pixels of the display unit and unit areas of the barrier unit. FIGS. 2 and 3 schematically illustrate dimensions and shapes, which are therefore not necessarily identical to the actual dimensions and shapes. A display device 1 illustrated in FIG. 1 is an example of the display device according to the present disclosure.

The display device 1 displays an image that can be recognized as a three-dimensional image by a user who views a screen from a predetermined position by the naked eyes. As illustrated in FIG. 1, the display device 1 includes a backlight 2, a display unit 4, a barrier unit 6, an imaging unit 8, a control unit 9, and a storage unit 10. In the display device 1, the backlight 2, the display unit 4, and the barrier unit 6 are stacked in this order, for example.

The backlight 2 is a planar illuminating device that emits planar light toward the display unit 4. The backlight 2 includes a light source and a light guide plate for example, and outputs light emitted by the light source from its emitting surface facing the display unit 4 through the light guide plate.

The display unit 4 is a display device that displays an image. The display unit 4 is a liquid crystal panel in which a plurality of pixels is arranged in a two-dimensional array as illustrated in FIG. 3. Light emitted from the backlight 2 enters the display unit 4. The display unit 4 displays an image on a display surface (4S in FIG. 2, for example) by switching between the transmission and blocking of light to enter each pixel.

The barrier unit 6 is arranged on the display surface (4S in FIG. 2, for example) of the display unit 4 on which an image is displayed, that is, on the surface of the display unit 4 opposite from the surface facing the backlight 2. In the barrier unit 6, a plurality of unit areas 150 that extend in a third direction (a Y-axis direction illustrated in FIGS. 2 and 3, for example) vertical to a first direction (an X-axis direction illustrated in FIGS. 2 and 3, for example) horizontal to the display surface (4S in FIG. 2, for example) of the display unit 4 are arranged in columns. The barrier unit 6 is a liquid crystal panel, and switches between the transmission and blocking of light to enter each of the unit areas 150, through a light emitting-side surface (6S in FIG. 2, for example). Therefore, the barrier unit 6 adjusts the area where an image displayed on the display unit 4 is transmitted and the area where an image displayed on the display unit 4 is blocked.

(Display Unit 4 and Barrier Unit 6)

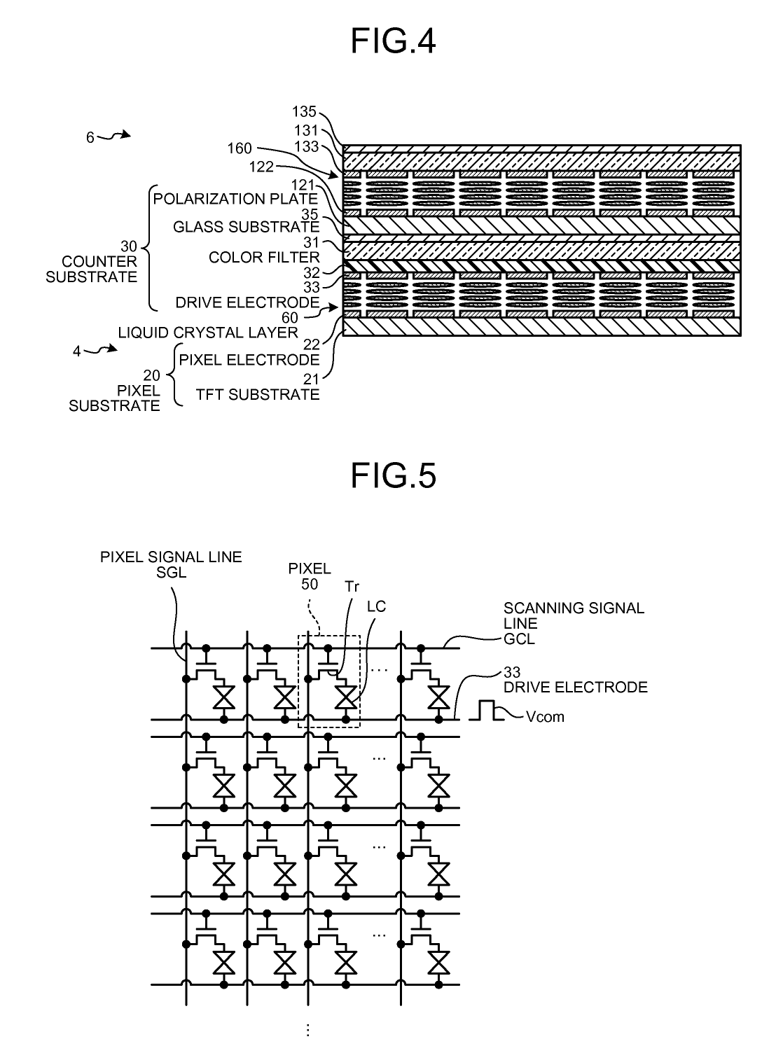

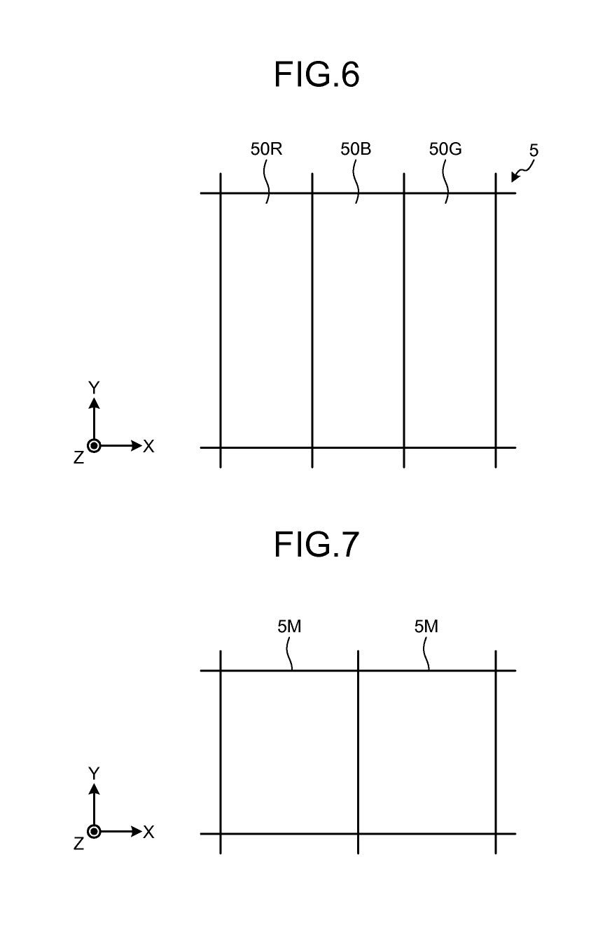

Next, a configuration example of the display unit 4 and the barrier unit 6 is explained. FIG. 4 is a cross-sectional view of a schematic cross-sectional structure of a module in which a display unit and a barrier unit are incorporated. FIG. 5 is a circuit diagram illustrating a pixel array in the display unit. FIG. 6 is a schematic diagram of a pixel for color display. FIG. 7 is a schematic diagram of a pixel for monochrome display.

As illustrated in FIG. 4, the display device 1 is configured by stacking the barrier unit 6 on the display unit 4. The display unit 4 includes a pixel substrate 20, a counter substrate 30 that is arranged to be opposed to the pixel substrate 20 in a direction vertical to the surface of the pixel substrate 20, and a liquid crystal layer 60 that is inserted between the pixel substrate 20 and the counter substrate 30.

The pixel substrate 20 includes a TFT substrate 21 that serves as a circuit board, and a plurality of pixel electrodes 22 that are provided in a matrix on the TFT substrate 21. In the TFT substrate 21, wiring including a TFT (Thin Film Transistor) element Tr of each pixel 50 illustrated in FIG. 5, a pixel signal line SGL that supplies a pixel signal to each of the pixel electrodes 22, a scanning signal line GCL that drives the TFT element Tr is formed. As described above, the pixel signal line SGL extends on a plane parallel to a surface of the TFT substrate 21, and supplies a pixel signal for displaying an image to a pixel. The pixel substrate 20 illustrated in FIG. 5 includes a plurality of pixels 50 that are arrayed in a matrix. Each of the pixels 50 includes the TFT element Tr and a liquid crystal LC. In an example illustrated in FIG. 5, the TFT element Tr is configured by an nMOS (n-channel Metal Oxide Semiconductor) type TFT element. A source of the TFT element Tr is connected to the pixel signal line SGL. A gate of the TFT element Tr is connected to the scanning signal line GCL. A drain of the TFT element Tr is connected to one end of the liquid crystal LC. One end of the liquid crystal LC is connected to the drain of the TFT element Tr, and the other end is connected to a drive electrode 33.

The pixels 50 belonging to the same row on the pixel substrate 20 are connected to each other by a scanning signal line GCL. The scanning signal line GCL is connected to a gate driver, and is supplied with a scanning signal (Vscan) from the gate driver. The pixels 50 belonging to the same column on the pixel substrate 20 are connected to each other by a pixel signal line SGL. The pixel signal line SGL is connected to a source driver, and is supplied with a pixel signal (Vpix) from the source driver. Further, the pixels 50 belonging to the same row on the pixel substrate 20 are connected to each other by a drive electrode 33. The drive electrode 33 is connected to a drive-electrode driver, and is supplied with a drive signal (Vcom) from the drive-electrode driver. That is, in an example illustrated in FIG. 5, pixels 50 belonging to the same row share one drive electrode 33.

The display unit 4 sequentially selects one row (one horizontal line) of pixels 50 arrayed in a matrix on the pixel substrate 2 as a display drive target by applying the scanning signal (Vscan) from the gate driver to the gate of the TFT element Tr of the pixel 50 through the scanning signal line GCL illustrated in FIG. 5. The display unit 4 supplies the pixel signal (Vpix) from the source driver to each of pixels 50 that constitute one horizontal line sequentially selected, through the pixel signal line SGL illustrated in FIG. 5. On the pixels 50, one-horizontal-line display is performed according to the pixel signal (Vpix) supplied. The display unit 4 applies the drive signal (Vcom) to drive the drive electrode 33.

As described above, the display unit 4 drives the scanning signal line GCL so as to perform line sequential scanning in a time-division manner, and therefore sequentially selects one horizontal line. The display unit 4 supplies the pixel signal (Vpix) to pixels 50 that belong to one horizontal line in order to perform display of each horizontal line. Upon performing this display operation, the display unit 4 applies the drive signal (Vcom) to a block that includes the drive electrode 33 that corresponds to the displayed one horizontal line.

The counter substrate 30 includes a glass substrate 31, a color filter 32 that is formed on a surface of the glass substrate 31, and a plurality of drive electrodes 33 that are formed on a surface of the color filter 32 opposite from the glass substrate 31. On the other surface of the glass substrate 31, a polarization plate 35 is provided. The barrier unit 6 is stacked on a surface of the polarization plate 35 opposite side from the glass substrate 31.

In the color filter 32, three color filters including for example red (R), green (G) and blue (B) are periodically arrayed, and a set of these RGB color filters is associated to each of pixels 50 illustrated in FIG. 5. Specifically, one pixel which is a unit for composing a color image (i.e. a unit pixel 5) may include a plurality of sub-pixels for example. In the example as illustrated in FIG. 6, the unit pixel 5 includes a sub-pixel 50R for displaying red (R), a sub-pixel 50B for displaying blue (B), and a sub-pixel 50G for displaying green (G). The sub-pixels 50R, 50B, and 50B of the unit pixel 5 are arrayed in the X-direction, i.e. in a row direction of the display device 1. The color filter 32 is opposed to the liquid crystal layer 60 in a direction vertical to the surface of the TFT substrate 21. For the color filter 32, other combination of colors may be used, insofar as such a combination includes different colors from each other.

The unit pixel 5 may further include a sub-pixel of one color or sub-pixels of plural colors. In a case where a reflective liquid crystal display device is only compatible with monochrome display, one pixel which is a unit for composing a monochrome image (i.e. a unit pixel 5M) corresponds to the unit pixel 5 for a color image, as illustrated in FIG. 7. The unit pixel 5 is a basic unit for displaying a color image. The unit pixel 5M is a basic unit for displaying a monochrome image.

In the present embodiment, the drive electrodes 33 function as common drive electrodes (counter electrodes) of the display unit 4. In the present embodiment, one drive electrode 33 is disposed in association with one pixel electrode 22 (the pixel electrode 22 that constitutes one row). The drive electrodes 33 may be a plate electrode that is common to the plurality of pixel electrodes 22. The drive electrodes 33 according to the present embodiment are opposed to the pixel electrodes 22 in a direction vertical to the surface of the TFT substrate 21, and extend in a direction parallel to the direction in which the pixel signal line SGL extends. A drive signal having an AC rectangular waveform is applied from the drive-electrode driver to the drive electrodes 33 through a contact conductive pillar (not illustrated) with conductive properties.

The liquid crystal layer 60 modulates light passing through it according to a state of an electric field, and uses various liquid-crystal modes such as TN (Twisted Nematic), VA (Vertical Alignment), ECB (Electrically Controlled Birefringence), and the like.

Respective alignment films are provided between the liquid crystal layer 60 and the pixel substrate 20 and between the liquid crystal layer 60 and the counter substrate 30. An incident-side polarization plate may also be arranged on the bottom-surface side of the pixel substrate 20.

The barrier unit 6 includes a TFT substrate 121 as a circuit board, a plurality of unit-area electrodes 122 that are disposed in columns on the TFT substrate 121, a glass substrate 131, a plurality of drive electrodes 133 that are disposed on one surface of the glass substrate 131 facing a side of the unit-area electrodes 122, and a polarization plate 135 that is disposed on the other surface of the glass substrate 131. An area interposed between a surface of the glass substrate 131 on the side of the drive electrodes 133 and a surface of the TFT substrate 121 on the side of the unit-area electrodes 122 is filled with a liquid crystal layer 160. The barrier unit 6 basically has the same configuration as the display unit 4 except that the unit-area electrodes 122 are disposed instead of the pixel electrodes 22 of the display unit 4, and the color filter 32 is not disposed for the barrier unit 6. Respective alignment films are provided between the liquid crystal layer 160 and the TFT substrate 121 and between the liquid crystal layer 160 and the glass substrate 131. An incident-side polarization plate may also be arranged on the bottom-surface side of the TFT substrate 121, that is, on the side of the display unit 4.

Each of the unit-area electrodes 122 has the same shape as the unit area 150 illustrated in FIG. 3, which is a long thin plate shape extending along a first direction. The unit-area electrodes 122 are arranged in plural columns in a second direction.

The display unit 4 and the barrier unit 6 have the configuration as described above, and respectively change the voltage to be applied to the pixel electrodes 22 and the unit-area electrodes 122 on the basis of a signal from the control unit 9, and therefore display an image that is visually recognized three dimensionally by a user.

The imaging unit 8 is a device that captures an image, such as a camera. For example, both in a head tracking technique and in an eye tracking technique, an image of a user is captured to utilize position information regarding the user's head and eyeballs in the image.

The control unit 9 controls an operation of each unit of the display device 1. Specifically, the control unit 9 controls turning on and off of the backlight 2, controls the amount and intensity of light at the time of turning-on, controls an image to be displayed on the display unit 4, controls an operation of each of the unit areas 150 (transmission and blocking of light) in the barrier unit 6, and controls an imaging operation of the imaging unit 8. The control unit 9 controls an image to be displayed on the display unit 4, and an operation of each of the unit areas 150 (transmission and blocking of light) in the barrier unit 6 to realize display of a three-dimensional image.

The control unit 9 may include a CPU (Central Processing Unit) that is a computation device, and a memory that is a storage device, for example, in order to execute a program by using these hardware resources, thereby realizing various functions. Specifically, for example, the control unit 9 reads a program stored in the storage unit 10, develops the program into the memory, and causes the CPU to execute a command included in the program developed into the memory. According to a result of the command execution by the CPU, the control unit 9 controls turning on and off the backlight 2, controls the amount and intensity of light at the time of turning-on, controls an image to be displayed on the display unit 4, and controls an operation of each of the unit areas 150 (transmission and blocking of light) in the barrier unit 6.

As illustrated in FIG. 1, the control unit 9 includes a detection unit 9a, a calculation unit 9b, a position estimation unit 9c, and an image adjustment unit 9d.

On the basis of an image of a user captured by the imaging unit 8, the detection unit 9a detects a position of the user in the first direction (the X-axis direction illustrated in FIG. 2, for example) horizontal to the display surface (4S in FIG. 2, for example) of the display unit 4 on which a moving image is displayed. For example, the detection unit 9a detects an outline of the user's face from the image of the user and identifies the position of the user's face in the image to detect the position of the user. For another example, on the basis of differences in the amount of light through the pupil, iris, and sclera contained in an image of the user, the detection unit 9a identifies positions of the user's eyeballs (right eye and left eye) in the image to detect the position of the user. The detection unit 9a is an example of the detection unit according to the present disclosure.

The calculation unit 9b calculates a moving speed of the user. Specifically, the calculation unit 9b acquires a frame time that is a display time per frame that constitutes a moving image to be displayed on the display unit 4. For example, when there are 30 frames per second, the frame time is one thirtieth of a second. Playing of a moving image may be carried out by reading data of the moving image from the storage unit 10 by the control unit 9, for example. Subsequently, the calculation unit 9b acquires, from the detection unit 9a, a position of the user detected by the detection unit 9a while a first frame is displayed on the display unit 4, and a position of the user detected by the detection unit 9a while a second frame to be displayed later than the first frame is displayed on the display unit 4. The position of the user acquired from the detection unit 9a by the calculation unit 9b is a user position in the X-axis direction illustrated in FIG. 2, for example. The calculation unit 9b calculates a moving speed of the user on the basis of a time duration from when the first frame is displayed on the display unit 4 to when the second frame is displayed on the display unit 4, and on the basis of an amount of transition (a moving distance of the user) from the position of the user when the first frame is displayed to the position of the user when the second frame is displayed. The calculation unit 9b is an example of the calculation unit according to the present disclosure.

The position estimation unit 9c calculates an estimated position of the user. Specifically, if the moving speed calculated by the calculation unit 9b is higher than a threshold value, the position estimation unit 9c calculates an estimated position of the user when the aforementioned second frame is to be displayed on the display unit 4, by means of the position of the user detected by the detection unit 9a while the second frame is displayed on the display unit 4, a detection processing time duration of the detection unit 9a required for detecting the position of the user while the second frame is displayed on the display device 4, and a moving speed calculated by the calculation unit 9b. On the other hand, if the moving speed calculated by the calculation unit 9b is equal to or less than the threshold value, the position estimation unit 9c does not calculate the estimated position of the user. The threshold value is predetermined to a value to determine whether the moving speed of the user is a speed corresponding to an irregular subtle movement of the user. For example, the threshold value may be set to 0.01 meters per second. The position estimation unit 9c is an example of the position estimation unit according to the present disclosure.

When an estimated position is calculated by the position estimation unit 9c, the image adjustment unit 9d performs adjustment of an image to be displayed on the display unit 4 on the basis of the estimated position. Specifically, the image adjustment unit 9d assumes that the line of sight of the user positioned at the estimated position calculated by the position estimation unit 9c is directed to a substantially center portion of the display unit 4. Next, the image adjustment unit 9d adjusts the moving image currently reproduced and displayed so that the image corresponding to the visual point of the user projected to the display unit 4 from the estimated position of the user becomes an image cut out by the field of vision of the user. As a method for adjusting an image, data for an image processing is prestored in the storage unit 10, for example. The data to be prestored may be data capable of displaying a three dimensional stereoscopic image corresponding to the visual point of the user for each moving image. The image adjustment unit 9d acquires the data for an image processing corresponding to the visual point of the user from among the processing data corresponding to the moving image currently reproduced and displayed, and adjusts the moving image currently reproduced and displayed by using the acquired data for the image processing.

The storage unit 10 includes a storage device that includes a magnetic storage device, a semiconductor storage device, or the like, and stores various programs and data therein. For example, the storage unit 10 stores programs therein for providing various functions to realize various kinds of processing to be executed by the control unit 9. Further, data of moving image to be reproduced and displayed on the display unit 4, data for image processing allowing three dimensional stereoscopic display corresponding to the visual point of the user, and the like, for example, may be stored in the storage unit 10 for each moving image.

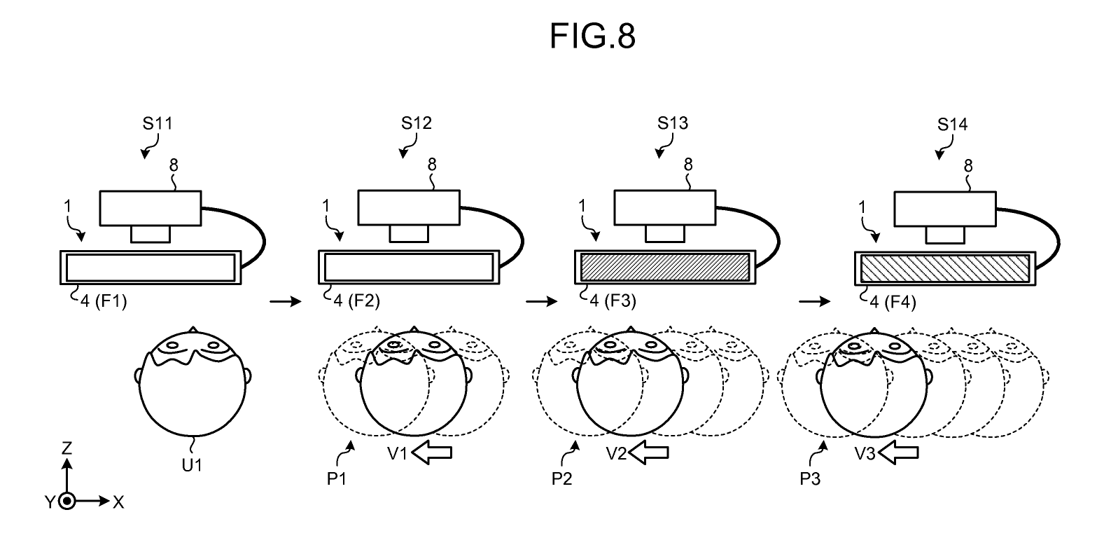

FIG. 8 is an explanatory diagram for illustrating an outline of processing by the display device according to the first embodiment. FIG. 8 illustrates a positional relationship between the display device 1 and the user U1 when viewed from above them. FIG. 8 also illustrates a situation that the user U1 moves in the X direction illustrated in FIG. 8 from step S11 to step S14 in this order.

As illustrated in FIG. 8, on the basis of an image of the user U1, the display device 1 detects a position of the user U1 when a frame F1 is displayed on the display unit 4 (see Step S11). Subsequently, on the basis of the frame time of the moving image currently reproduced and displayed and a moving amount (transition amount) of the position of the user U1, the display device 1 calculates a moving speed V1 of the user U1 (see Step S12). For example, the display device 1 may calculate the moving speed V1, for example, on the basis of the frame time from when an image of the frame F1 is displayed on the display unit 4 to when an image of a frame F2 is displayed on the display unit 4, and the moving amount (transition amount) from the position of the user U1 when the image of the frame F1 is displayed on the display unit 4 to the position of the user U1 when the image of the frame F2 is displayed on the display unit 4 (a moving distance of the user U1 in the X-axis direction).

Next, the display device 1 determines whether the moving speed V1 of the user U1 is higher than a threshold value. If the moving speed V1 is higher than the threshold value, the display device 1 calculates an estimated position P1 of the user U1 at the time of displaying the image of the frame F2 on the display unit 4 (see Step S12). For example, the display device 1 calculates the estimated position P1 of the user U1 on the basis of the position of the user U1 when the image of the frame F2 is displayed on the display unit 4, a detection processing time required for detecting the position of the user U1, and the moving speed V1. That is, the display device 1 calculates the estimated position P1 by adding a moving distance of the user U1 during the processing time required for recognizing the position of the user U1 to the position of the user U1 when the image of the frame F2 is displayed on the display unit 4. Therefore, it is possible to estimate a user position, while dealing with an internal processing delay due to user position recognition. The display device 1 determines whether the moving speed V1 of the user U1 is higher than a threshold value. If the moving speed V1 is equal to or lower than a threshold value, the display device 1 does not perform calculation of an estimated position of the user U1 at the time of displaying the image of the frame F2 on the display unit 4.

Next, the display device 1 adjusts the image of the frame F2 displayed on the display unit 4 on the basis of the estimated position P1 of the user U1 (Step S13).

When the moving image is currently reproduced and displayed, the display device 1 subsequently calculates a moving speed V2 of the user U1, on the basis of a frame time of the moving image currently reproduced and displayed and a moving amount of the position of the user U1 (see Step S13). For example, the display device 1 calculates the moving speed V2 on the basis of a frame time from when the image of the frame F2 is displayed on the display unit 4 to when an image of a frame F3 is displayed on the display unit 4, and on the basis of an amount of transition (a moving distance of the user U1 in the X-axis direction) from the position of the user U1 when the image of the frame F2 is displayed on the display unit 4 to the position of the user U1 when the image of the frame F3 is displayed on the display unit 4.

Next, the display device 1 determines whether the moving speed V2 of the user U1 is higher than a threshold value. If the moving speed V2 is higher than a threshold value, the display device 1 calculates an estimated position P2 of the user U1 at the time of displaying the image of the frame F3 on the display unit 4 (see Step S13), similarly to Step S12 described above. For example, the display device 1 calculates the estimated position P2 of the user U1 on the basis of the position of the user U1 when the image of the frame F3 is displayed on the display unit 4, a detection processing time required for detecting the position of the user U1, and the moving speed V2. The display device 1 determines whether the moving speed V2 of the user U1 is higher than a threshold value. If the moving speed V2 is equal to or lower than a threshold value, the display device 1 does not perform calculation of an estimated position of the user U1 at the time of displaying the image of the frame F3 on the display unit 4.

Subsequently, the display device 1 adjusts the image of the frame F3 displayed on the display unit 4, on the basis of the estimated position P2 of the user U1 (Step S14).

Thereafter, when a moving image is being played, the display device 1 repeatedly performs the same processing as at Step S12 and Step S13 described above. That is, the display device 1 calculates a moving speed V3 of the user U1, on the basis of a frame time of the moving image currently reproduced and on the basis of an amount of transition of the position of the user U1 (see Step S14). Next, when the moving speed V3 of the user U1 is higher than a threshold value, the display device 1 calculates an estimated position P3 of the user U1 at the time of displaying an image of a frame F4 on the display unit 4, and adjusts the image of the frame F4 displayed on the display unit 4 on the basis of the estimated position P3 of the user U1.

(Flow of Control by Control Unit 9)

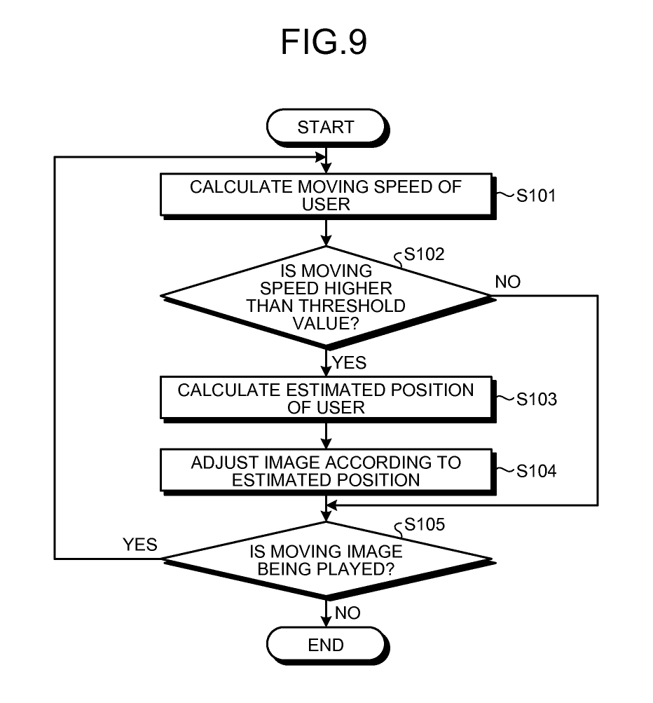

With reference to FIG. 9, a flow of control by the display device according to the first embodiment is explained. FIG. 9 is a flowchart illustrating a flow of control by the display device according to the first embodiment. The control illustrated in FIG. 9 is executed simultaneously with starting the playing of a moving image, for example.

As illustrated in FIG. 9, the control unit 9 detects a user position on the basis of an image acquired by the imaging unit 8, and calculates a moving speed “Vx” of the user by using the following formula (1), on the basis of a frame time of a moving image currently played and a moving amount of the user position (Step S101). In the following formula (1), “Xnew” represents a detected position of the user when an image of a second frame is displayed on the display unit 4. In the following formula (1), “Xold” represents a detected position of the user when an image of a first frame to be displayed earlier than the second frame is displayed on the display unit 4. In the following formula (1), “Tc” represents a frame time.

$$\begin{matrix}[ Formula 1 ] & \\ {v}_{x} = \frac{{x}_{new} - {x}_{old}}{{T}_{c}} & ( 1 )\end{matrix}$$

Subsequently, the control unit 9 determines whether the moving speed “Vx” calculated at Step S101 is higher than a threshold value “Vth” (Step S102).

As a result of the determination, if the moving speed “Vx” is higher than the threshold value “Vth” (YES at Step S102), the control unit 9 calculates an estimated position “X′new” of the user by using the following formula (2) (Step S103). In the following formula (2), “Tdelay” represents a processing time required for detecting a user position.

[Formula 2]

X′_{new}=X_{new}+VₓT_{delay}(Vx≧Vth) (2)

Next, the control unit 9 adjusts an image displayed on the display unit 4 according to the estimated position “X′new” calculated at Step S103 (Step S104). The control unit 9 then determines whether the moving image is currently reproduced and displayed (Step S105).

As a result of the determination, if the moving image is currently reproduced and displayed (YES at Step S105), the control unit 9 returns to the step S101 described above to continue the control illustrated in FIG. 9. In contrast, as a result of the determination, if the moving image is not currently reproduced and displayed (NO at Step S105), the control unit 9 finishes the control illustrated in FIG. 9.

At Step S102 described above, when the control unit 9 determines whether the moving speed “Vx” calculated at Step S101 is higher than the threshold value “Vth”, and as a result of the determination, if the moving speed “Vx” is equal to or lower than the threshold value “Vth” (NO at Step S102), the control unit 9 does not calculates the estimated position “X′new” of the user. As expressed in the following formula (3), the control unit 9 handles the estimated position “X′new” of the user as the same as the detected position “Xnew”. The control unit 9 then shifts to the step S105 described above to determine whether the moving image is currently reproduced and displayed.

[Formula 3]

X′_{new}=X_{new}(Vₓ<Vₜₕ) (3)

As described above, in the first embodiment, if a moving speed of a user is equal to or lower than a threshold value, the display device 1 does not calculate an estimated position of the user. That is, the display device according to the present disclosure does not perform estimation of a user position on the basis of an irregular subtle movement of the user at a relatively low moving speed, for example. Therefore, the display device according to the present disclosure can eliminate a possibility to cause an error in estimating the user position as much as possible so as to prevent the occurrence of an error in the estimated user position.

### 1-2. Second Embodiment

A functional configuration of a display device according to a second embodiment is explained. The display device according to the second embodiment is different from the display device according to the first embodiment in points explained below.

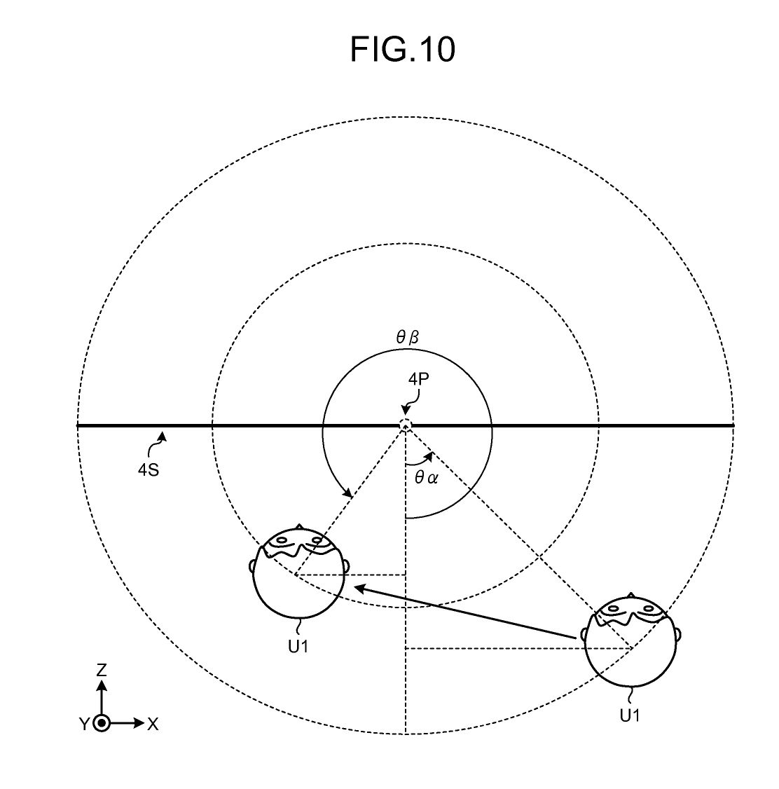

The detection unit 9a detects a position of a user in a first direction (an X-axis direction illustrated in FIG. 2, for example) horizontal to a display surface (4S illustrated in FIG. 2, for example) of the display unit 4 on which a moving image is displayed, and detects a position of the user in a second direction (a Z-axis direction illustrated in FIG. 2, for example) vertical to the display surface. Subsequently, the detection unit 9a detects an angular position of the user relative to the display surface, on the basis of the positions of the user in the first and second directions. FIG. 10 illustrates an example of an angular position of the user. The detection unit 9a uses a predetermined point 4P on the display surface 4S of the display unit 4 as an origin to quantitatively detect the angular position of the user (θα and θβ, for example) by using a trigonometric function of the positions in the X-axis and Z-axis directions.

The calculation unit 9b acquires, from the detection unit 9a, an angular position of the user detected by the detection unit 9a when a first frame is displayed on the display unit 4, and an angular position of the user detected by the detection unit 9a when a second frame having a display order later than the first frame is displayed on the display unit 4. Subsequently, the calculation unit 9b calculates a moving angular speed of the user, on the basis of a time duration from when the first frame is displayed on the display unit 4 to when the second frame is displayed on the display unit 4, and on the basis of a moving amount from the angular position of the user when the first frame is displayed to the angular position of the user when the second frame is displayed.

If the moving angular speed calculated by the calculation unit 9b is higher than a threshold value, the position estimation unit 9c calculates an estimated position of the user at the time of displaying the above second frame on the display unit 4 by using the angular position detected by the detection unit 9a at the time of displaying the above second frame on the display unit 4, a detection processing time required for the detection unit 9a to detect the angular position at the time of displaying the above second frame on the display unit 4, and the moving angular speed calculated by the calculation unit 9b, for example. In contrast, if the moving angular speed calculated by the calculation unit 9b is equal to or lower than a threshold value, the position estimation unit 9c does not calculate an estimated position of the user.

(Flow of Control by Control Unit 9)

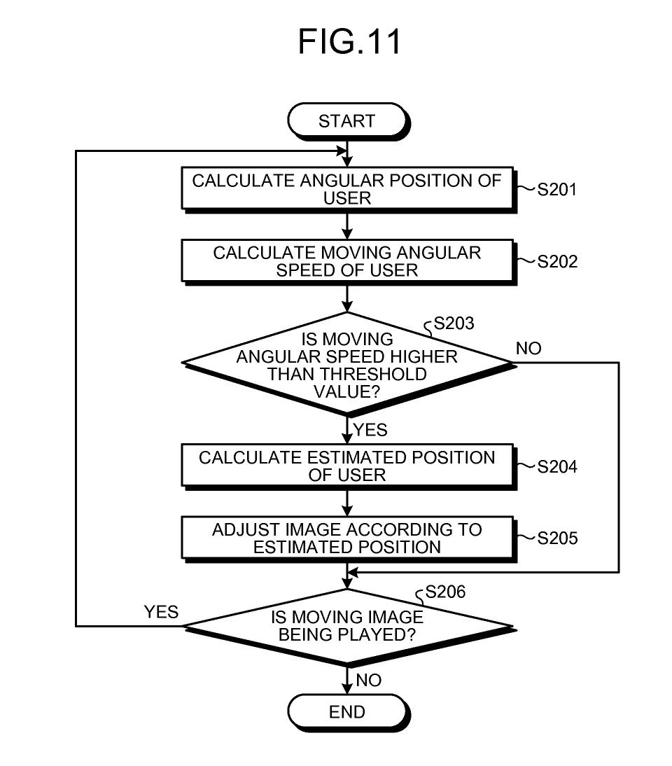

With reference to FIG. 11, a flow of control by the display device according to the second embodiment is explained. FIG. 11 is a flowchart illustrating a flow of control by the display device according to the second embodiment. The control illustrated in FIG. 11 may be executed synchronously with a start of a moving image reproduction, for example.

As illustrated in FIG. 11, the control unit 9 detects a position of a user on the basis of an image acquired by the imaging unit 8, and then detects an angular position of the user from the detected position on the basis of the following formulas (4) and (5) (Step S201). In the following formula (4), “Xnew” represents a detected position of the user in an X-axis direction (see FIG. 10 and the like) when an image of a second frame is displayed on the display unit 4. In the following formula (4), “Znew” represents a detected position of the user in a Z-axis direction (see FIG. 10 and the like) when the image of the second frame is displayed on the display unit 4. In the following formula (5), “Xold” represents a detected position of the user in the X-axis direction (see FIG. 10 and the like) when an image of a first frame to be displayed earlier than the second frame is displayed on the display unit 4. In the following formula (5), “Zold” represents a detected position of the user in the Z-axis direction (see FIG. 10 and the like) when the image of the first frame to be displayed earlier than the second frame is displayed on the display unit 4.

$$\begin{matrix}[ Formula 4 ] & \\ tan {θ}_{New} = \frac{{x}_{New}}{{z}_{New}} & ( 4 ) \\ [ Formula 5 ] & \\ tan {θ}_{old} = \frac{{x}_{old}}{{z}_{old}} & ( 5 )\end{matrix}$$

Next, the control unit 9 calculates a moving angular speed “VA” of the user according to the following formula (6), on the basis of a frame time of a moving image currently reproduced and displayed and a moving amount of the angular position of the user detected at Step S201 (Step S202).

$$\begin{matrix}[ Formula 6 ] & \\ {v}_{θ} = \frac{{θ}_{new} - {θ}_{old}}{{T}_{c}} & ( 6 )\end{matrix}$$

Subsequently, the control unit 9 determines whether the moving angular speed “Vθ” calculated at Step S202 is higher than a threshold value “Vθth” (Step S203). The threshold value “Vθth” can be obtained by converting the threshold value “Vth” used for the processing by the control unit 9 in the first embodiment, on the basis of the following formula (7). By obtaining the threshold value according to the angular speed on the basis of the following formula (7), a determination can be made taking into account the movement of the user in the Z-axis direction (see FIG. 10 and the like).

$$\begin{matrix}[ Formula 7 ] & \\ tan {v}_{θ}^{th} = \frac{{v}_{th}}{{z}_{New}} & ( 7 )\end{matrix}$$

As a result of the determination, if the moving angular speed “VA” is higher than the threshold value “Vθth” (YES at Step S203), the control unit 9 calculates an estimated position “θ′new” of the user by using the following formula (8) (Step S204).

[Formula 8]

θ′_{new}=θ_{new}+V_{θ}T_{delay}(V_{θ}≧V_{θ}^{th}) (8)

Next, the control unit 9 adjusts an image displayed on the display unit 4 according to the estimated position “θ′new” calculated at Step S204 (Step S205). The control unit 9 then determines whether the moving image is currently reproduced and displayed (Step S206).

As a result of the determination, if the moving image is currently reproduced and displayed (YES at Step S206), the control unit 9 returns to the step S201 described above to continue the control illustrated in FIG. 11. In contrast, as a result of the determination, if the moving image is not currently reproduced and displayed (NO at Step S206), the control unit 9 finishes the control illustrated in FIG. 11.

At Step S203 described above, when the control unit 9 determines whether the moving angular speed “Vθ” calculated at Step S202 is higher than the threshold value “Vθth”, and as a result of the determination, if the moving angular speed “Vθ” is equal to or lower than the threshold value “Vθth” (NO at Step S203), the control unit 9 does not calculate the estimated position “θ′new” of the user. As expressed in the following formula (9), the control unit 9 handles the estimated position “θ′new” of the user as the same as the detected position “θnew”. The control unit 9 then shifts to the step S206 described above to determine whether the moving image is currently reproduced and displayed.

[Formula 9]

θ′_{new}=θ_{new}(V_{θ}<V_{θ}^{th}) (9)

### 1-3. Third Embodiment

A functional configuration of a display device according to a third embodiment is explained. The display device 1 according to the third embodiment controls the barrier unit 6 so that a right eye image to be displayed on the display unit 4 enters the right eye of the user and a left eye image to be displayed on the display unit 4 enters the left eye of the user. Thereby, the display device 1 according to the third embodiment performs a processing to display an image (3D image), which can be viewed three dimensionally by the user as a viewer, on the display unit 4. In the third embodiment, if the moving speed of the user is higher than the threshold, the display device 1 performs a processing to control the light transmission through the barrier unit 6, depending on the estimated position of the user, in order to ensure the parallax of the user. This will be described later in detail.

The detection unit 9a detects an angular position of the user, similarly to the second embodiment. That is, the detection unit 9a detects a position of the user in a first direction (an X-axis direction illustrated in FIG. 2, for example) horizontal to a display surface (4S illustrated in FIG. 2, for example) of the display unit 4 on which a moving image is displayed, and detects a position of the user in a second direction (a Z-axis direction illustrated in FIG. 2, for example) vertical to the display surface. Subsequently, the detection unit 9a detects an angular position (see FIG. 10, and the like) of the user relative to the display surface on the basis of the positions of the user in the first and second directions.

The calculation unit 9b calculates a moving angular position of the user, similarly to the second embodiment. That is, the calculation unit 9b acquires, from the detection unit 9a, an angular position of the user, detected by the detection unit 9a when a first frame is displayed on the display unit 4, and an angular position of the user, detected by the detection unit 9a when a second frame having a display order later than the first frame is displayed on the display unit 4. Subsequently, the calculation unit 9b calculates a moving angular speed of the user on the basis of a time from when the first frame is displayed on the display unit 4 to when the second frame is displayed on the display unit 4, and on the basis of an amount of transition from the angular position of the user when the first frame is displayed to the angular position of the user when the second frame is displayed.

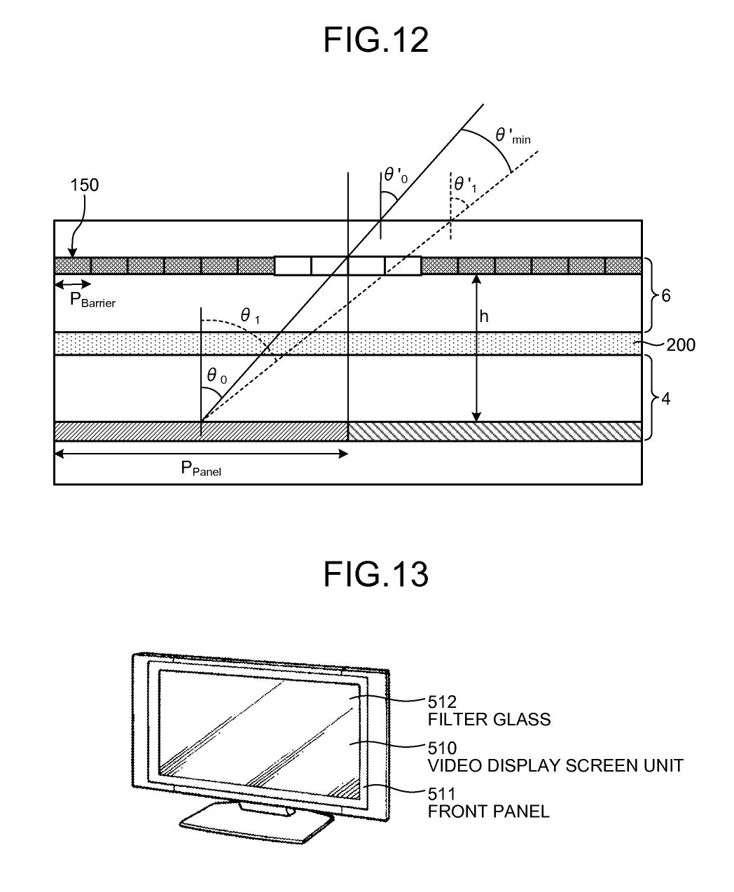

The position estimation unit 9c determines whether a visual-angle moving amount of the user corresponding to the moving angular speed of the user requires a shift of the unit area 150 in the barrier unit 6. With reference to FIG. 12, a determination by the position estimation unit 9c is explained below. FIG. 12 is an explanatory diagram for illustrating control of the display device according to the third embodiment. FIG. 12 illustrates a schematic cross section of the display unit 4 and the barrier unit 6 that are stacked through a predetermined adhesive layer. In FIG. 12, “θ′min” represents a unit angle for shifting a viewpoint angle, “θ′0” represents an optimum visual angle, and “θ′1” represents a combined angle of the optimum visual angle with the unit angle for shifting a viewpoint angle. In FIG. 12, “θ0” represents a within-panel optimum visual angle (a visual angle inner side of the panel than the barrier unit 6). In FIG. 12, “θ1” represents a within-panel combined angle (a visual angle inner side of the panel than the barrier unit 6) of the optimum visual angle with the unit angle for shifting a viewpoint angle. In FIG. 12, “Ppanel” represents a pitch of a pixel pattern (a panel pitch), “PBarrier” represents a pitch of a barrier pattern (a barrier pitch), and “h” represents a spacing between the barrier pattern (the barrier unit 6) and pixels (the display unit 4).

As illustrated in FIG. 12, the display unit 4 and the barrier unit 6 are stacked in the order illustrated in FIG. 12 via an adhesive layer 200. In the barrier unit 6, the unit areas 150 that extend in a third direction (a Y-axis direction illustrated in FIGS. 2 and 3, for example) vertical to the first direction (the X-axis direction illustrated in FIGS. 2 and 3, for example) horizontal to the display surface (4S in FIG. 2, for example) of the display unit 4 are arranged in columns. The barrier unit 6 is an example of the parallax adjustment unit according to the present disclosure.

The unit angle “θ′min” illustrated in FIG. 12 can be expressed by the following formula (10). The unit angle “θ′min” represents a unit angle for a viewpoint angle for controlling transmission of light through the barrier unit 6.

[Formula 10]

θ′ₘᵢₙ=θ′₁−θ′₀ (10)

The visual angle “θ′1” outside of the barrier unit 6 and the visual angle “θ′0” outside of the barrier unit 6, which are both illustrated in FIG. 12, can be expressed by the following formula (11) on the basis of the Snell's formula.

[Formula 11]

sin θ′₁=n sin θ₁

sin θ′₀=n sin θ₀ (11)

For example, the formula (11) can be approximated as expressed by the following formula (12) when assuming “θ” is close to the central angle (0 degree) and is sufficiently small.

[Formula 12]

θ′₁≈nθ₁

θ′₀≈nθ₀

θ′ₘᵢₙ≈n(θ₁−θ₀) (12)

Visual angles “θ0” and “θ1” inside of the barrier unit 6, illustrated in FIG. 12, can be expressed by the following formula (13) by using the panel pitch “Ppanel” of the display unit 4, the barrier pitch “PBarrier” of the barrier unit 6, and the spacing “h” between the display unit 4 and the barrier unit 6, which are all illustrated in FIG. 12.

$$\begin{matrix}[ Formula 13 ] & \\ tsn {θ}_{0} = \frac{{p}_{panel}}{2 h} \\ tsn {θ}_{1} = \frac{{p}_{panel} / 2 + {p}_{Barrier}}{h} & ( 13 )\end{matrix}$$

As described above, the formula (13) can be approximated when assuming “θ” is sufficiently small. Thereby, the unit angle “θ′min” required for shifting a viewpoint angle can be expressed by the following formula (14).

$$\begin{matrix}[ Formula 14 ] & \\ {θ}_{0} ≅ \frac{{p}_{panel}}{2 h} \\ {θ}_{1} = \frac{{p}_{panel} / 2 + {p}_{Barrier}}{h} \\ {θ}_{min}^{′} ≅ n \frac{{p}_{Barrier}}{h} & ( 14 )\end{matrix}$$

When assuming that the moving angular speed “Vθ” of a user calculated by the calculation unit 9b is constant, the deviation of the visual angle of the user can be suppressed within the unit area 150 of the barrier unit 6 in a condition that a visual angle moving amount “VθTdelay” taking account of the processing time duration “Tdelay” of the detection unit 9a is equal to or less than the unit angle “θ′min”, as expressed by the following formula (15).

$$\begin{matrix}[ Formula 15 ] & \\ {v}_{θ} {T}_{Delay} < {θ}_{min}^{′} = n \frac{{p}_{Barrier}}{h} & ( 15 )\end{matrix}$$

From the above formula (15), a threshold speed when a visual-angle moving amount corresponding to the moving angular speed “Vθ” of the user is equal to or less than the unit angle “θ′min” can be obtained as expressed by the following formula (16).

$$\begin{matrix}[ Formula 16 ] & \\ {v}_{θ} < n \frac{{p}_{Barrier}}{h {T}_{Delay}} & ( 16 )\end{matrix}$$

The position estimation unit 9c determines whether the moving angular speed “Vθ” of the user calculated by the calculation unit 9b is higher than the threshold speed expressed in the above formula (16) and thereby determines whether the visual-angle moving amount corresponding to the moving angular speed “Vθ” of the user becomes equal to or less than the unit angle “θ′min”. When the moving angular speed “Vθ” is higher than the threshold speed expressed by the above formula (16), the position estimation unit 9c performs calculation of an estimated position of the user. For example, the position estimation unit 9c calculates an estimated position of the user when the above second frame is displayed on the display unit 4 by using the angular position detected by the detection unit 9a when the above second frame is displayed on the display unit 4, a detection processing time required for the detection unit 9a to detect the angular position when the above second frame is displayed on the display unit 4, and the moving angular speed calculated by the calculation unit 9b. In contrast, when the moving angular speed “Vθ” is equal to or lower than the threshold speed expressed by the above formula (16), the position estimation unit 9c does not perform processing itself for calculating an estimated position of the user.

When an estimated position is calculated by the position estimation unit 9c, the image adjustment unit 9d performs a shift of the area where light is transmitted among the unit areas 150 included in the barrier unit 6 on the basis of the calculated estimated position and on the basis of pixel arrays in an image for the right eye and in an image for the left eye, which constitute a moving image.

In this manner, when a moving speed of a user exceeds a threshold value, the display device 1 according to the third embodiment realizes processing for controlling transmission of light through the barrier unit 6 according to an estimated position of the user in order to ensure a parallax of the user.

### 2. APPLICATION EXAMPLES

As application examples of the present disclosure, examples in which the display device 1 described above is applied to an electronic apparatus are explained.

FIGS. 13 to 25 illustrate an example of an electronic apparatus that includes the display device according to the above embodiments. It is possible to apply the display device 1 according to the above embodiments to electronic apparatuses in any field, including a portable phone, a portable terminal device such as a smart phone, a television device, a digital camera, a laptop personal computer, a video camera, meters provided in a vehicle, and the like. In other words, it is possible to apply the display device 1 according to the above embodiments to electronic apparatuses in any field, which display a video signal input externally or a video signal generated internally as an image or a video. The electronic apparatuses include a control device that supplies a video signal to a display device to control an operation of the display device.

### Application Example 1

An electronic apparatus illustrated in FIG. 13 is a television device to which the display device 1 according to the above embodiments is applied. This television device includes a video display screen unit 510 that includes a front panel 511 and a filter glass 512, for example. The video display screen unit 510 is the display device according to the above embodiments.

### Application Example 2

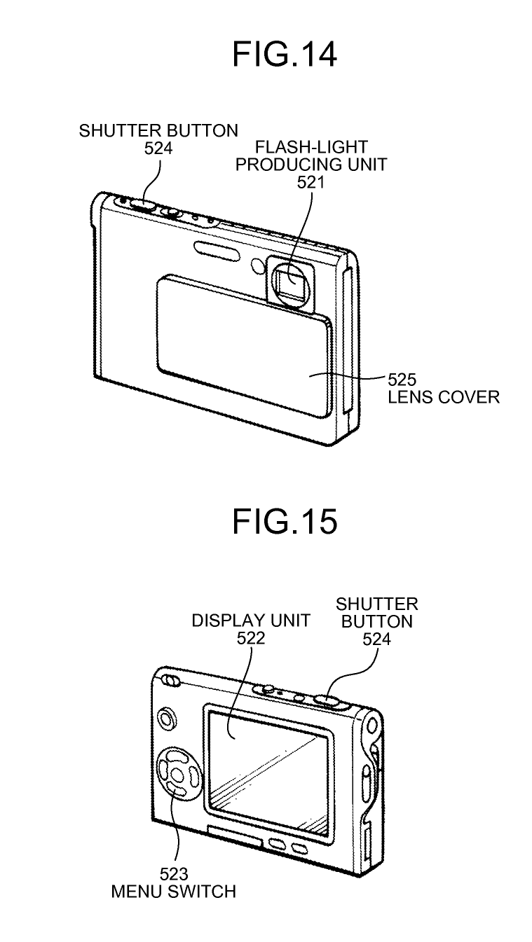

An electronic apparatus illustrated in FIGS. 14 and 15 is a digital camera to which the display device 1 according to the above embodiments is applied. This digital camera includes a flash-light producing unit 521, a display unit 522, a menu switch 523, and a shutter button 524, for example. The display unit 522 is the display device according to the above embodiments. As illustrated in FIG. 14, the digital camera includes a lens cover 525, and slides the lens cover 525 to expose an image-capturing lens. A digital camera can image light incident from its image-capturing lens to capture a digital photograph.

### Application Example 3

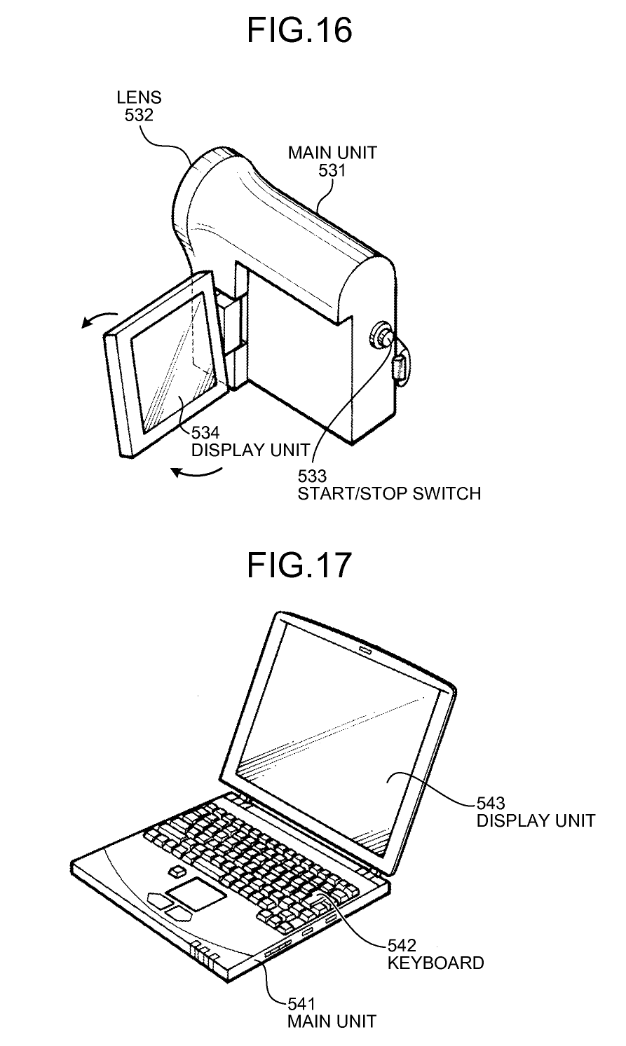

An electronic apparatus illustrated in FIG. 16 is a video camera to which the display device 1 according to the above embodiments is applied, and FIG. 16 illustrates its external appearance. This video camera includes a main unit 531, a subject capturing lens 532 that is provided on the front side of the main unit 531, an image-capturing start/stop switch 533, and a display unit 534, for example. The display unit 534 is the display device according to the above embodiments.

### Application Example 4

An electronic apparatus illustrated in FIG. 17 is a laptop personal computer to which the display device 1 according to the above embodiments is applied. This laptop personal computer includes a main unit 541, a keyboard 542 for an operation to input text and the like, and a display unit 543 that displays an image. The display unit 543 is configured by the display device according to the above embodiments.

### Application Example 5

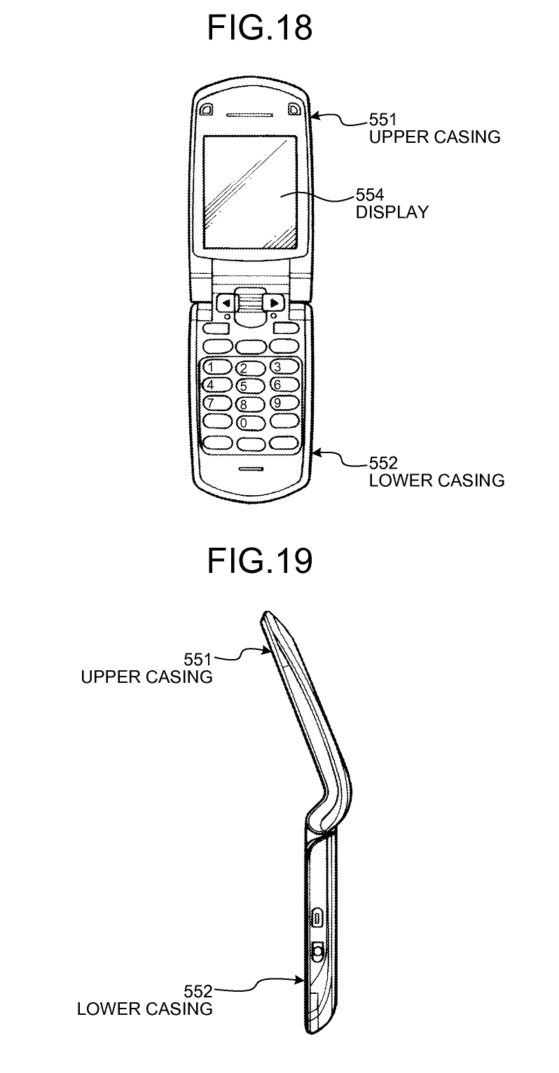

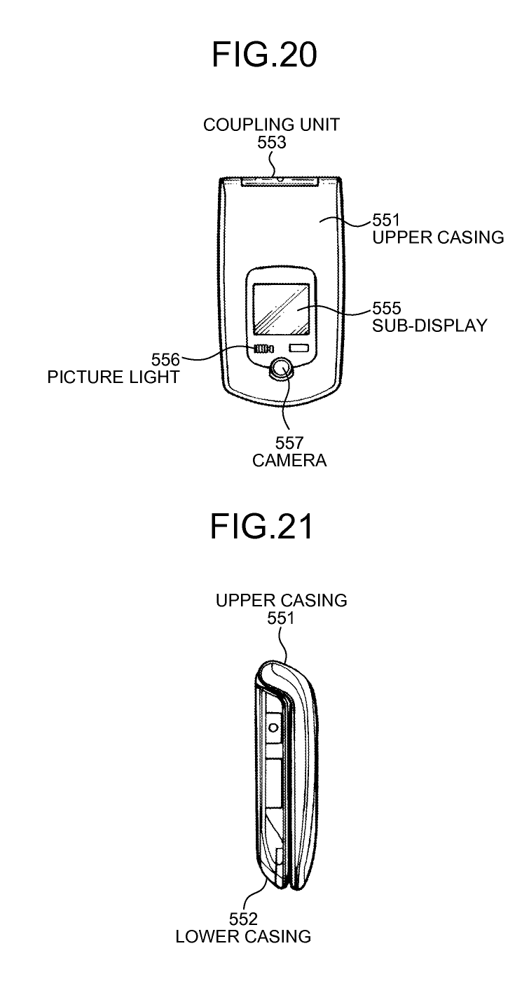

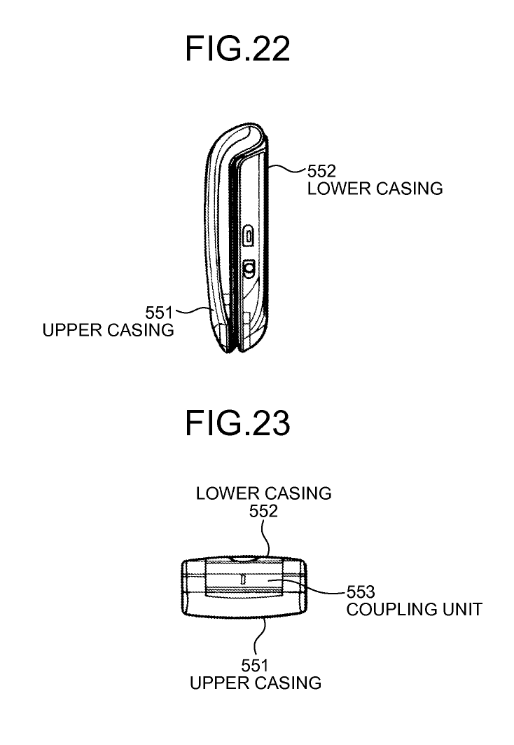

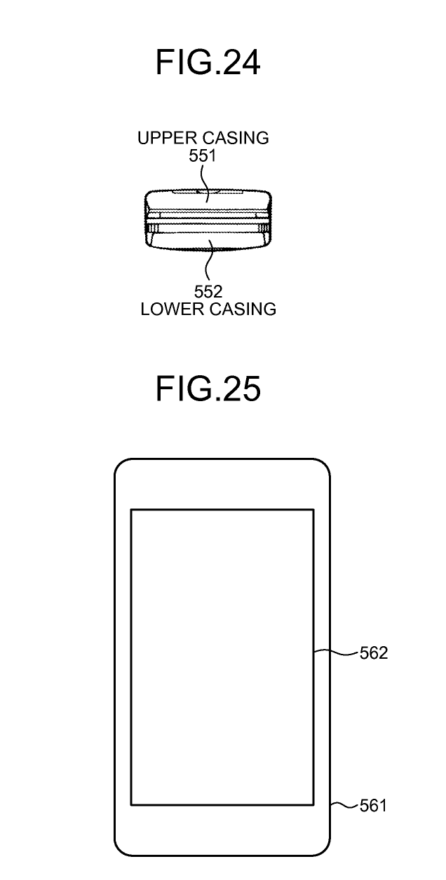

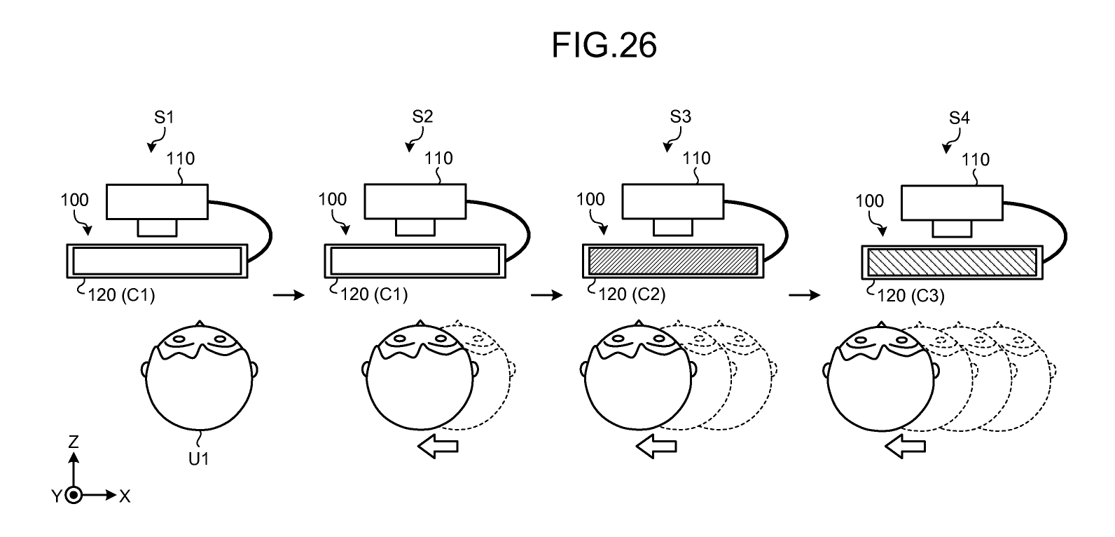

An electronic apparatus illustrated in FIGS. 18 to 24 is a portable phone to which the display device 1 according to the above embodiments is applied. FIG. 18 is a front view of the portable phone in an opened state. FIG. 19 is a right side view of the portable phone in an opened state. FIG. 20 is a top view of the portable phone in a folded state. FIG. 21 is a left side view of the portable phone in a folded state. FIG. 22 is a right side view of the portable phone in a folded state. FIG. 23 is a rear view of the portable phone in a folded state. FIG. 24 is a front view of the portable phone in a folded state. This portable phone is configured by coupling an upper casing 551 and a lower casing 552 by a coupling unit (a hinge) 553, and includes a display 554, a sub-display 555, a picture light 556, and a camera 557. The display 554 or the sub-display 555 is configured by the display device according to the above embodiments. The display 554 of the portable phone can have a function of detecting a touch operation in addition to a function of displaying an image.

### Application Example 6

An electronic apparatus illustrated in FIG. 25 is a portable information terminal that operates as a portable computer, a multi-functional portable phone, a portable computer capable of making a voice call, or a portable computer capable of other forms of communication, and that is also referred to as so-called “smart phone” or “tablet terminal”. This portable information terminal includes a display unit 562 on a surface of a casing 561, for example. The display unit 562 is the display device according to the above embodiments.

According to the display device disclosed herein, an error of estimated position of a user can be reduced as much as possible in processing to control or adjust an image according to the estimated position of the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### 3. CONFIGURATION OF THE PRESENT DISCLOSURE

The present disclosure can also employ the following configurations.
(1) A Display Device Comprising:

a display unit configured to display a moving image;

a detection unit configured to detect a position of a user, on the basis of an image of a user, in a first direction horizontal to a display surface of the display unit on which the moving image is displayed;

a calculation unit configured to calculate a moving speed of the user, on the basis of a frame time that is a display time per frame composing the moving image, and on the basis of an amount of transition from a position detected by the detection unit during a time of displaying a first frame on the display unit to a position detected by the detection unit during a time of displaying a second frame on the display unit, the second frame being to be displayed later than the first frame;

a position estimation unit configured to,
when the moving speed calculated by the calculation unit is higher than a threshold value,
calculate an estimated position of the user during a time of displaying the second frame on the display unit, on the basis of the position detected by the detection unit during a time of displaying the second frame on the display unit, a detection processing time required for the detection unit to detect the position during a time of displaying the second frame on the display unit, and the moving speed calculated by the calculation unit, and
when the moving speed is equal to or lower than the threshold value,
calculate no estimated position; and

an image adjustment unit configured to, when the estimated position is calculated by the position estimation unit, perform adjustment of an image to be displayed on the display unit on the basis of the estimated position.
(2) The display device according to (1), wherein

the detection unit detects the position of the user in the first direction, and a position of the user in a second direction vertical to the display surface, and detects an angular position of the user relative to the display surface, on the basis of the positions of the user in the first direction and the second direction,

the calculation unit calculates a moving angular speed of the user, on the basis of the frame time and of the basis of an amount of transition from an angular position detected by the detection unit during a time of displaying the first frame to an angular position detected by the detection unit during a time of displaying the second frame on the display unit, and

the position estimation unit calculates, when the moving angular speed is higher than a threshold value, the estimated position during a time of displaying the second frame on the display unit, on the basis of the angular position detected by the detection unit during a time of displaying the second frame on the display unit, the detection processing time required for detecting the angular position during a time of displaying the second frame on the display unit, and the moving angular speed calculated by the calculation unit, and when the moving angular speed is equal to or lower than a threshold value, the position estimation unit does not calculate the estimated position.
(3) The display device according to (2), further comprising a parallax adjustment unit disposed on a side of the display surface, the parallax adjustment including a plurality of unit areas extending in a third direction vertical to the first direction and arranged in columns in the first direction, wherein

the display unit displays a moving image that can be visually recognized three dimensionally by the user,

the position estimation unit calculates, when a visual-angle moving amount of the user corresponding to the moving angular speed of the user requires a switch of the unit area, the estimated position during a time of displaying the second frame on the display unit, on the basis of the angular position detected by the detection unit during a time of displaying the second frame on the display unit, the detection processing time required for detecting the angular position during a time of displaying the second frame on the display unit, and the moving angular speed calculated by the calculation unit, and when the visual-angle moving amount does not require a switch of the unit area, the position estimation unit does not calculate the estimated position, and

the image adjustment unit switches, when the estimated position is calculated by the position estimation unit, an area for transmitting light therethrough among the unit areas included in the parallax adjustment unit, on the basis of the estimated position calculated by the position estimation unit and on the basis of pixel arrays in an image for a right eye and in an image for a left eye, which constitute the moving image.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. display device comprising:
a display unit configured to display a moving image;
a detection unit configured to detect a position of a user, on the basis of an image of a user, in a first direction horizontal to a display surface of the display unit on which the moving image is displayed;
a calculation unit configured to calculate a moving speed of the user, on the basis of a frame time that is a display time per frame composing the moving image, and on the basis of an amount of transition from a position detected by the detection unit during a time of displaying a first frame on the display unit to a position detected by the detection unit during a time of displaying a second frame on the display unit, the second frame being to be displayed later than the first frame;
a position estimation unit configured to,
when the moving speed calculated by the calculation unit is higher than a threshold value,
calculate an estimated position of the user during a time of displaying the second frame on the display unit, on the basis of the position detected by the detection unit during a time of displaying the second frame on the display unit, a detection processing time required for the detection unit to detect the position during a time of displaying the second frame on the display unit, and the moving speed calculated by the calculation unit, and
when the moving speed is equal to or lower than the threshold value,
calculate no estimated position; and
an image adjustment unit configured to, when the estimated position is calculated by the position estimation unit, perform adjustment of an image to be displayed on the display unit on the basis of the estimated position.

2. The display device according to claim 1,
the detection unit detects the position of the user in the first direction, and a position of the user in a second direction vertical to the display surface, and detects an angular position of the user relative to the display surface, on the basis of the positions of the user in the first direction and the second direction,
the calculation unit calculates a moving angular speed of the user, on the basis of the frame time and of the basis of an amount of transition from an angular position detected by the detection unit during a time of displaying the first frame to an angular position detected by the detection unit during a time of displaying the second frame on the display unit, and
the position estimation unit calculates, when the moving angular speed is higher than a threshold value, the estimated position during a time of displaying the second frame on the display unit, on the basis of the angular position detected by the detection unit during a time of displaying the second frame on the display unit, the detection processing time required for detecting the angular position during a time of displaying the second frame on the display unit, and the moving angular speed calculated by the calculation unit, and when the moving angular speed is equal to or lower than a threshold value, the position estimation unit does not calculate the estimated position.

3. The display device according to claim 2, further comprising a parallax adjustment unit disposed on a side of the display surface, the parallax adjustment including a plurality of unit areas extending in a third direction vertical to the first direction and arranged in columns in the first direction,
the display unit displays a moving image that can be visually recognized three dimensionally by the user,
the position estimation unit calculates, when a visual-angle moving amount of the user corresponding to the moving angular speed of the user requires a switch of the unit area, the estimated position during a time of displaying the second frame on the display unit, on the basis of the angular position detected by the detection unit during a time of displaying the second frame on the display unit, the detection processing time required for detecting the angular position during a time of displaying the second frame on the display unit, and the moving angular speed calculated by the calculation unit, and when the visual-angle moving amount does not require a switch of the unit area, the position estimation unit does not calculate the estimated position, and
the image adjustment unit switches, when the estimated position is calculated by the position estimation unit, an area for transmitting light therethrough among the unit areas included in the parallax adjustment unit, on the basis of the estimated position calculated by the position estimation unit and on the basis of pixel arrays in an image for a right eye and in an image for a left eye, which constitute the moving image.
